(19) United States
(12) Patent Application Publication
(10) Pub. No.: US 2009/0066619 A1
(43) Pub. Date: Mar. 12, 2009

(54) Liquid crystal panel and liquid crystal display utilizing the same

(75) Inventor: Hung-Yu Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/231,778

(22) Filed: Sep. 5, 2008

(30) Foreign Application Priority Data
Sep. 7, 2007 (CN) 200710077024.7

(51) Int. Cl. G09G 3/36

(52) U.S. Cl. 345/87

(57) ABSTRACT

A liquid crystal panel (200) includes parallel gate lines (212), and parallel data lines (213) insulatingly intercrossing the gate lines. The gate lines and the data lines define a plurality of pixel regions (211). Each pixel region includes a first thin film transistor (TFT) (215), a second TFT (216), a first pixel electrode (217), and a second pixel electrode (218). The first TFT includes a first gate electrode connected with the gate line, a first source electrode connected with the data line, and a first drain electrode connected with the first pixel electrode. The second TFT includes a second gate electrode (2162), a second source electrode (2161), and a second drain electrode (2163). The second gate electrode is connected with a gate line via a voltage dividing element. The second drain electrode is connected with the second pixel electrode.

### FIELD OF THE INVENTION

The present invention relates to liquid crystal panels, and particularly to a multi-domain vertical alignment (MVA) liquid crystal panel and a liquid crystal display (LCD) using the MVA liquid crystal panel.

### GENERAL BACKGROUND

LCDs have the advantages of portability, low power consumption, and low radiation, and have been widely used in various portable information products such as notebooks, personal digital assistants (PDAs), video cameras and the like. A conventional LCD such as a twisted nematic (TN) LCD provides a limited viewing angle. Thus, MVA LCDs were developed to improve the viewing angle.

Referring to FIG. 11, a typical MVA liquid crystal panel is shown. The liquid crystal panel 100 includes a first substrate assembly (not shown), a second substrate assembly generally facing the first substrate assembly, and a liquid crystal layer (not labeled) sandwiched between the first substrate assembly and the second substrate assembly. The liquid crystal layer includes a plurality of liquid crystal molecules 131.

The first substrate assembly includes a color filter (not shown), a common electrode (not shown), and a plurality of first protrusions 119, arranged in that order. The color filter includes a plurality of red filter units (not shown), a plurality of green filter units (not shown), and a plurality of blue filter units (not shown). The first protrusions 119 each are triangular in cross-section, and are arranged along a plurality of V-shaped paths.

The second substrate assembly includes a plurality of parallel gate lines 112 that each extend parallel to a first axis, a plurality of first parallel data lines 113 that each extend parallel to a second axis orthogonal to the first axis, a plurality of parallel second data lines 114 each extending parallel to the second axis, a plurality of first thin film transistors (TFTs) 115, a plurality of second TFTs 116, a plurality of first pixel electrodes 117, a plurality of second pixel electrodes 118, and a plurality of second protrusions 129.

The first data lines 113 and the second data lines 114 are arranged alternately. Every two adjacent first data lines 113, together with every two adjacent gate lines 112, form a rectangular area, defined as a pixel region 111. Each pixel region 111 corresponds to a filter unit of the color filter. Each second data line 114 is disposed across the middle of a corresponding pixel region 111, and divides the pixel region 111 into a first sub-pixel region 101 and a second sub-pixel region 102.

In each pixel region 111, the first TFT 115 is located in the vicinity of an intersection of the first data line 113 and the gate line 112. The second TFT 116 is located in the vicinity of an intersection of the second data line 114 and the gate line 112. Gate electrodes (not labeled) of the first TFT 115 and the second TFT 116 are connected to the same gate line 112. A source electrode (not labeled) of the first TFT 115 is connected to the first data line 113. A source electrode (not labeled) of the second TFT 116 is connected to the second data line 114. The first pixel electrode 117 is located in the first sub-pixel region 101, connected with a drain electrode (not labeled) of the first TFT 115. The second pixel electrode 116 is located in the second sub-pixel region 102, connected with a drain electrode (not labeled) of the second TFT 116. The first data line 113 provides a plurality of first gray-scale voltages to the corresponding first pixel electrode 117 via the first TFT 115. The second data line 114 provides a plurality of second gray-scale voltages to the corresponding second pixel electrode 118 via the second TFT 116. The first gray-scale voltages and the second gray-scale voltages are applied thereto independently.

The second protrusions 129 each are triangular in cross-section, arranged along a plurality of V-shaped paths. The second protrusions 129 and the first protrusions 119 are arranged alternately.

Referring also to FIG. 12, an equivalent circuit diagram of one pixel region 111 of FIG. 11 is shown. The first pixel electrode 117, the common electrode, and the liquid crystal layer sandwiched therebetween cooperatively form a first liquid crystal capacitor 104. The second pixel electrode 118, the common electrode, and the liquid crystal layer sandwiched therebetween cooperatively form a second liquid crystal capacitor 105.

Referring also to FIG. 13, a top-down view of orientations of four of the liquid crystal molecules 131, according to the first protrusions 119 and the second protrusions 129, is shown. In each frame, when a first gray-scale voltage is applied to the first pixel electrode 117, and a common voltage is applied to the common electrode, an electric field is generated therebetween. The liquid crystal molecules 131 in the first sub-pixel region 101 re-orient according to the electric field. The liquid crystal molecules 131 are guided by the protrusions 119, 129 and thereby become aligned along four different axes. Thus four domains are defined according to the protrusions 119, 129.

Similarly, in the same frame, when a second gray-scale voltage is applied to the second pixel electrode 118, and a common voltage is applied to the common electrode, an electric field is generated therebetween. The liquid crystal molecules 131 in the second sub-pixel region 102 re-orient according to the electric field. The liquid crystal molecules 131 are guided by the protrusions 119, 129 and thereby align along four different axes. Thus four domains are defined according to the protrusions 119, 129. Referring also to FIG. 14, because the voltages of the first pixel electrode 117 differ from the voltage of the second pixel electrode 118 in each frame, a tilt angle θ₃ of the liquid crystal molecules 131 in the first sub-pixel region 101 differs from a tilt angle θ₄ of the liquid crystal molecules 131 in the second sub-pixel region 102. Thus, a total of eight domains are defined in each pixel region 111. The liquid crystal panel 100 achieves 8-domain vertical alignment.

However, each pixel region 111 requires a first data line 113 and a second data line 114 for the liquid crystal panel 100 to perform the 8-domain vertical alignment. The layout of the first data line 113 and the second data line 114 is complicated, resulting in an increase of cost thereof.

It is desired to provide an improved liquid crystal panel and an LCD which can overcome the limitations described.

### SUMMARY

In one embodiment, a liquid crystal panel includes parallel gate lines with parallel data lines insulatingly intercrossing the gate lines. The gate lines and the data lines define a plurality of pixel regions, each including a first thin film transistor (TFT), a second TFT, a first pixel electrode, and a second pixel electrode. The first TFT includes a first gate electrode connected with the gate line, a first source electrode connected with the data line, and a first drain electrode connected with the first pixel electrode. The second TFT includes a second gate electrode, a second source electrode, and a second drain electrode. The second gate electrode is connected with a gate line via a voltage dividing element. The second drain electrode is connected with the second pixel electrode.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a top plan view of part of a liquid crystal panel according to a first embodiment of the present invention, the liquid crystal panel defining a plurality of pixel regions each divided into a first sub-pixel region and a second sub-pixel region, each pixel region including a plurality of liquid crystal molecules, a first TFT, a second TFT, and a coupling electrode.

FIG. 2 is an enlarged, schematic view of a circled portion II of FIG. 1.

FIG. 3 is a schematic, side view of one liquid crystal panel taken along line III-III of FIG. 2.

FIG. 4 is an equivalent circuit diagram of one of the pixel regions of FIG. 1.

FIG. 5 is a schematic, side view showing an active channel of the second TFT of FIG. 1.

FIG. 6 is a top-down view of orientations of four of the liquid crystal molecules of FIG. 1.

FIG. 7 is a schematic, side view of one of the liquid crystal molecules in the first sub-pixel region and one of the liquid crystal molecules in the second sub-pixel region of FIG. 1, the liquid crystal molecules having different tilt angles.

FIG. 8 is similar to FIG. 3, but shows a corresponding view of a resistor of a liquid crystal panel according to a second embodiment of the present invention.

FIG. 9 is an equivalent circuit diagram of the liquid crystal panel of FIG. 8.

FIG. 10 is a schematic, side view of an LCD of the present invention using the liquid crystal panels of FIG. 8.

FIG. 11 is a top plan view of a conventional liquid crystal panel, defining a plurality of pixel regions, each divided into a first sub-pixel region and a second sub-pixel region, each pixel region including a plurality of liquid crystal molecules.

FIG. 12 is an equivalent circuit diagram of one of the pixel regions of FIG. 11.

FIG. 13 is a top-down view of orientations of four of the liquid crystal molecules in the pixel region of FIG. 12.

FIG. 14 is a schematic, side view of one of the liquid crystal molecules in the first sub-pixel region and one of the liquid crystal molecules in the second sub-pixel region of FIG. 11, the liquid crystal molecules having different tilt angles.

### DETAILED DESCRIPTION OF PREFERRED EMBODIMENTS

Reference will now be made to the drawings to describe preferred and exemplary embodiments of the present invention in detail.

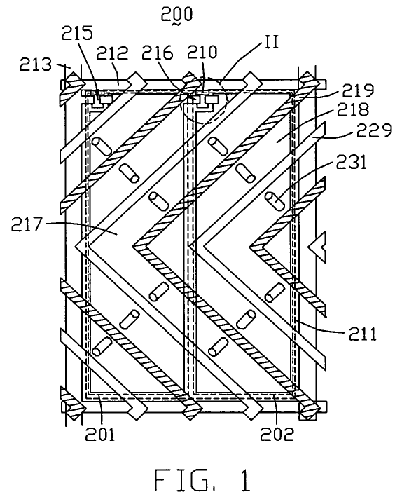

Referring to FIG. 1, a liquid crystal panel 200 according to a first embodiment of the present invention includes a first substrate assembly (not labeled), a second substrate assembly (not labeled) parallel to the first substrate assembly, and a liquid crystal layer (not labeled) sandwiched between the two substrate assemblies. The liquid crystal layer includes a plurality of liquid crystal molecules 231.

The first substrate assembly includes a color filter (not shown), a common electrode (not shown), and a plurality of first protrusions 219, arranged in that order. The color filter includes a plurality of red filter units (not shown), a plurality of green filter units (not shown), and a plurality of blue filter units (not shown). The first protrusions 219 are parallel, each having a triangular cross-section and arranged along a plurality of V-shaped paths.

The second substrate assembly includes a plurality of parallel gate lines 212, each extending along a first axis, a plurality of parallel data lines 213, each extending along a second axis orthogonal to the first axis, a plurality of first TFTs 215 (TFTs), a plurality of second TFTs 216, a plurality of first pixel electrodes 217, a plurality of second pixel electrodes 218, and a plurality of second protrusions 229.

Every two adjacent gate lines 212 and every two adjacent data lines 213 cooperatively form a rectangular area defined as a pixel region 211. Each pixel region 211 corresponds to a filter unit of the color filter. Each pixel region includes a first sub-pixel region 201 and a second sub-pixel region 202. Each first sub-pixel region 201 includes one of the first TFTs 215 and one of the first pixel electrodes 217. The first TFT 215 is disposed in the vicinity of an intersection of the gate line 212 and the data line 213. The first TFT 213 includes a first gate electrode (not labeled), a first source electrode (not labeled), and a first drain electrode (not labeled).

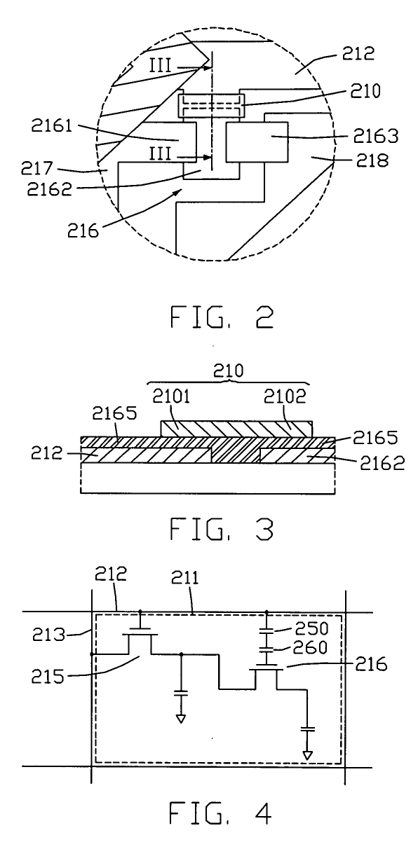

Referring also to FIG. 2, each second sub-pixel region 202 includes one second TFT 216, one second pixel electrodes 218, and a coupling electrode 210. The second TFT 216 includes a second source electrode 2161, a second gate electrode 2162, and a second drain electrode 2163. The second source electrode 2161 is electrically connected with the first pixel electrode 217. The second gate electrode 2162 is electrically connected with the gate line 212 via the coupling electrode 210. The coupling electrode 210 can be made from material the same as the first pixel electrode 217 and the second pixel electrode 218, such as indium tin oxide (ITO) or indium zinc oxide (IZO).

Referring also to FIG. 3 and FIG. 4, an enlarged, side view of the liquid crystal panel 200 taken along line III-III, and an equivalent circuit diagram of one of the pixel regions 211 are shown. An insulating layer 2165 covers the gate line 212 and the second gate electrode 2162 of the second TFT 216. The coupling electrode 210 is disposed on the insulating layer 2165. The coupling electrode 210 includes a first part 2101 and a second part 2102. The first part 2101 superposes a part of the gate line 212. The second part 2102 superposes a part of the second gate electrode 2162. The first part 2101, the insulating layer 2165, and the corresponding part of gate line 212 cooperatively form a first capacitor 250. The second part 2102, the insulating layer 2165, and the corresponding part of the second gate electrode 2162 cooperatively form a second capacitor 260. The first capacitor 250 and the second capacitor 260 are connected in series. That is, the second gate electrode 2162 is electrically connected with the gate line 212 via the second capacitor 260 and the first capacitor 250.

When the gate line 212 applies a scanning voltage to the first TFT 215 and the second TFT 216, a voltage of the first gate electrode of the first TFT 215 is substantially equal to the scanning voltage. The first TFT 215 is completely switched on. A data voltage of the data line 213 is completely applied to the first pixel electrode 217 via the first TFT 215 without a voltage drop. The voltage of the first pixel electrode 217 is substantially equal to the data voltage of the data line 212.

Because the first capacitor 250 and the second capacitor 260 generate voltage drops, respectively, a voltage of the second gate electrode 2162 is less than the scanning voltage. That is, the second TFT 216 is incompletely switched on. Referring to FIG. 5, an active channel 216 of the second TFT 216 is shown. When the second gate electrode 2162 receives the scanning voltage having a voltage drop on the capacitors 250, 260, a plurality of electrons are accumulated under a lower surface of the insulating layer 2165, whereby the active channel 216 is formed. Because the actual scanning voltage applied thereto is less, accumulated electrons are correspondingly fewer, such that the active channel 216 is narrow. Accordingly, equivalent resistance of the active channel 216 increases, and when a current flows through the second TFT 216, the active channel 216 generates a voltage drop, resulting in the data voltage of the data line 213 being partly applied to the second electrode 218, with voltage thereof falling below that of the voltage of the first pixel electrode 217.

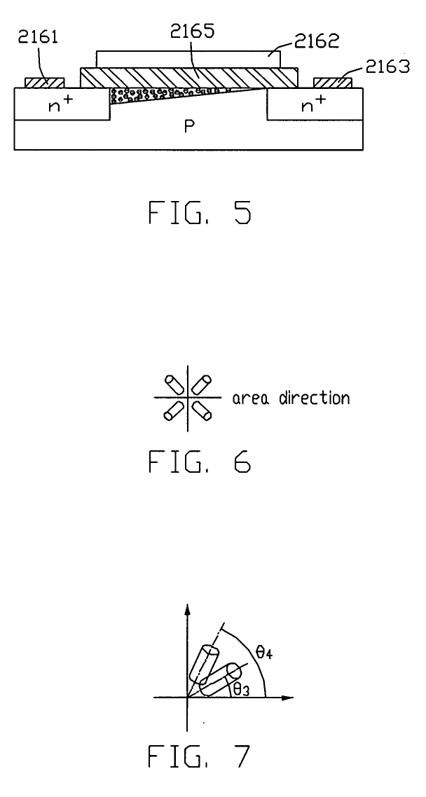

FIG. 6 and FIG. 7 are a top-down view and a side view of orientations of certain of the liquid crystal molecules 231 in the pixel region 211 of FIG. 4. When corresponding voltages are applied to the first pixel electrode 217, the second pixel electrode 218 and the common electrode, electric fields are generated. The liquid crystal molecules 231 re-orient according to the electric fields. The liquid crystal molecules 231 are guided by the first protrusions 219 and the second protrusions 229, thereby aligning along four different axes. Thus four domains are defined accordingly.

Because the voltage of the first pixel electrode 217 differs from that of the second pixel electrode 218 in each frame, tilt angles θ₁ of the liquid crystal molecules 231 corresponding to the first pixel electrode 217 differ from tilt angles θ₂ of the liquid crystal molecules 231 corresponding to the second pixel electrode 218. Thus, a total of eight domains are defined in the pixel region 211. The liquid crystal panel 200 achieves 8-domain vertical alignment.

Unlike conventional liquid crystal panels, liquid crystal panel 200 employs the coupling electrode 210 to form the first capacitor 250 and the second capacitor 260. The coupling electrode 210 functions as a voltage dividing element. The first capacitor 250 and the second capacitor 260 drop the voltage of the second pixel electrode 218 below that of the first pixel electrode 217 and incite a voltage difference between the first pixel electrode 217 and the second pixel electrode 218. No auxiliary data line is needed to apply a different voltage to the second pixel electrode 218. That is, each pixel region 211 of the liquid crystal panel 200 needs only one data line 213 to achieve 8-domain vertical alignment. Layout of the data lines 213 is simplified, and the cost of the liquid crystal panel 200 reduced correspondingly.

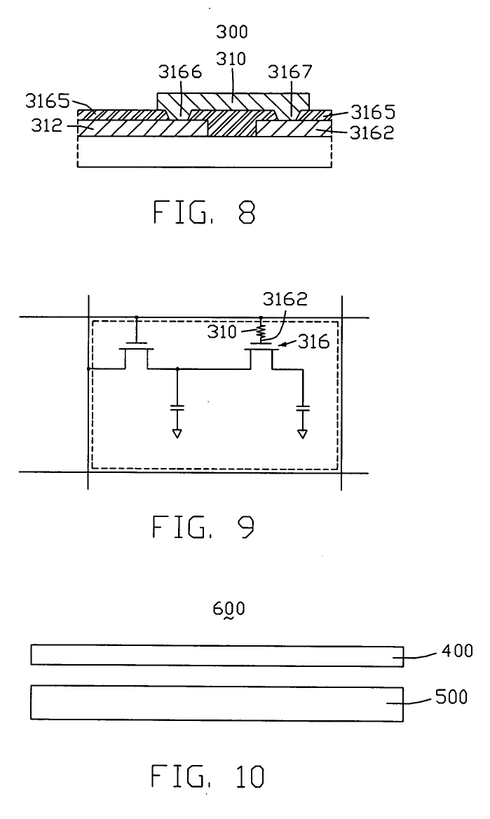

Referring to FIG. 8 and FIG. 9, a side view of a part of a liquid crystal panel according to a second embodiment of the present invention is shown, and an equivalent circuit diagram of one pixel region of the liquid crystal panel of FIG. 8 is shown. The liquid crystal panel 300 is similar to the liquid crystal panel 200, differing only in that the liquid crystal panel 300 includes a resistor 310 rather than a coupling electrode. The resistor 310 functions as a voltage dividing element. A second gate electrode 3162 of a second TFT 316 is connected with a gate line 312 via the resistor 310.

An insulating layer 3165 covers the gate line 312 and the second gate electrode 3162. The insulating layer 3165 defines a first connecting hole 3166 and a second connecting hole 3167. The resistor 310 is disposed on the insulating layer 3165. An end of the resistor 310 is connected with the gate line 312 via the first connecting hole 3166. The other end of the resistor 310 is connected with the second gate electrode 3162 via the second connecting hole 3167. The resistor 310 can be semi-conductor material.

When a scanning voltage is applied to the second gate electrode 3162 via the resistor 310, the resistor 310 generates a voltage drop. That is, the voltage of the second gate electrode 3162 is reduced, and the second TFT 316 is incompletely switched on. The second TFT 316 generates a voltage drop when a data line applies a data voltage to a second pixel electrode. That is, the voltage of the second pixel electrode is less than the data voltage of the data line. Because the voltage of the first pixel electrode is substantially equal to the data voltage of the data line, the voltage of the second pixel electrode is less than the voltage of the first pixel electrode. The liquid crystal panel 300 can achieve 8-domain vertical alignment.

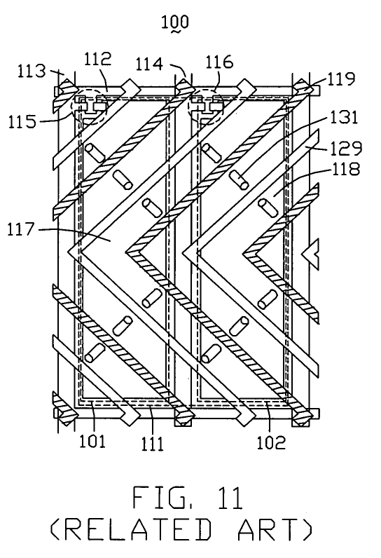

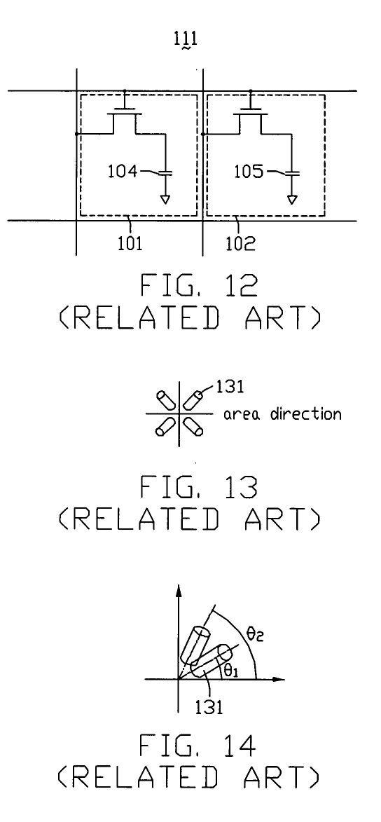

Referring to FIG. 10, a liquid crystal display (LCD) according to the present invention is shown. The LCD 600 includes a liquid crystal panel 400 and a backlight module 500 parallel to the liquid crystal panel 400. The backlight module 500 provides uniform light for the liquid crystal panel 400. The liquid crystal panel 400 can be a liquid crystal panels 200, 300.

Further or alternative embodiments may include, in a first example, the second source electrodes of the second TFTs 216, 316 connecting with the same data lines as the first source electrodes of the first TFTs, and the second source electrodes of the second TFTs 216, 316 connecting with the corresponding first drain electrodes of the first TFTs.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A liquid crystal panel comprising:
a plurality of gate lines;
a plurality of data lines insulatingly intercrossing the gate lines, thereby defining a plurality of pixel regions;
wherein each pixel region comprises a first thin film transistor (TFT), a second TFT, a first pixel electrode, and a second pixel electrode, the first TFT comprising a first gate electrode connected with the gate line, a first source electrode connected with the data line, and a first drain electrode connected with the first pixel electrode, the second TFT comprising a second gate electrode, a second source electrode, and a second drain electrode, the second gate electrode connected with a gate line via a voltage dividing element, and the second drain electrode connected with the second pixel electrode.

2. The liquid crystal panel of claim 1, wherein the second source electrode is selectively connected to one of a group consisting of the gate line, the first drain electrode, and the first pixel electrode.

3. The liquid crystal panel of claim 1, wherein the voltage dividing element is a coupling electrode.

4. The liquid crystal panel of claim 3, further comprising an insulating layer covering the gate line and the second gate electrode, the coupling electrode disposed on the insulating layer, the coupling electrode, the gate line, and the second gate electrode forming at least one capacitor, the second gate electrode connected with the gate line via the at least one capacitor.

5. The liquid crystal panel of claim 4, wherein the coupling electrode comprises a first part corresponding to a part of the gate line, and a second part corresponding to a part of the second gate electrode.

6. The liquid crystal panel of claim 5, wherein the first part of the coupling electrode and the gate line form a first capacitor, and the second part of the coupling electrode forms a second capacitor, the second gate electrode connecting with the gate electrode via the first capacitor and the second capacitor.

7. The liquid crystal panel of claim 1, wherein the voltage dividing element is a resistor.

8. The liquid crystal panel of claim 7, further comprising an insulating layer covering the gate line and the second gate electrode, the insulating layer defining a first connecting hole corresponding to the gate line, and a second connecting hole corresponding to the second gate electrode.

9. The liquid crystal panel of claim 8, wherein the resistor is disposed on the insulating layer and is connected with the gate line and the second gate electrode via the first connecting hole and the second connecting hole, respectively.

10. The liquid crystal panel of claim 1, further comprising a first substrate and a parallel second substrate, wherein inner surfaces of the first substrate and the second substrate comprise a plurality of protrusions arranged alternatingly.

11. A liquid crystal panel comprising:
a plurality of gate lines,
a plurality of data lines insulatingly intercrossing the gate lines,
wherein the gate lines and the data lines define a plurality of pixel regions, each pixel region comprising a first pixel electrode, a second pixel electrode, and a first TFT, the first TFT comprising a first gate electrode, a first source electrode, and a first drain electrode, the first source electrode connected with the first pixel electrode, the first drain electrode connected with the second pixel electrode, and the first gate electrode connected with the gate line via a voltage dividing element.

12. The liquid crystal panel of claim 11, wherein each pixel region further comprises a second TFT, comprising a second gate electrode connected with the gate line, a second source electrode connected with the data line, and a second drain electrode connected with the first pixel electrode.

13. The liquid crystal panel of claim 11, wherein the voltage dividing element is a coupling electrode.

14. The liquid crystal panel of claim 13, further comprising an insulating layer covering the gate line and the first gate electrode, the coupling electrode disposed on the insulating layer, the coupling electrode, the gate line, and the first gate electrode forming at least one capacitor, and the first gate electrode connected with the gate line via the at least one capacitor.

15. The liquid crystal panel of claim 11, wherein the voltage dividing element is a resistor.

16. The liquid crystal panel of claim 15, further comprising an insulating layer covering the gate line and the first gate electrode, the insulating layer defining a first connecting hole corresponding to the gate line, and a second connecting hole corresponding to the first gate electrode.

17. The liquid crystal panel of claim 16, wherein the resistor is disposed on the insulating layer and is electrically connected between the gate line and the first gate electrode via the first connecting hole and the second connecting hole, respectively.

18. A liquid crystal display (LCD), comprising:
a liquid crystal panel, comprising:
a plurality of gate lines;
a plurality of data lines insulatingly intercrossing the gate lines,
wherein the gate lines and the data lines define a plurality of pixel regions; each pixel region comprising a first thin film transistor (TFT), a second TFT, a first pixel electrode, and a second pixel electrode, the first TFT comprising a first gate electrode connected with the gate line, a first source electrode connected with the data line, and a first drain electrode connected with the first pixel electrode, the second TFT comprising a second gate electrode, a second source electrode, and a second drain electrode, the second gate electrode connected with a gate line via a voltage dividing element, the second drain electrode connected with the second pixel electrode, the second source electrode being selectively connected to one of a group consisting of the data line, the first drain electrode, and the first pixel electrode; and
a backlight module parallel to the liquid crystal panel.

19. The LCD of claim 18, wherein the voltage dividing element is a coupling electrode.

20. The LCD of claim 19, wherein the voltage dividing element is a resistor.
